(19) United States
(12) Patent Application Publication
(10) Pub. No.: US 2010/0205423 A1
(43) Pub. Date: Aug. 12, 2010

(54) BIOS, COMPUTER DEVICE AND METHOD FOR RECOVERING BIOS

(75) Inventors: Ming-Yang Shao, Shanhai City (CN); Lai Kong, Shanhai City (CN); Yin Deng, Shanhai City (CN); Guo-Juan Xin, Shanhai City (CN); Zhong-Ying Qu, Shanhai City (CN); Eric Chiou, Taipei City (TW)

Correspondence Address: EDWARDS ANGELL PALMER & DODGE LLP, P.O. BOX 55874, BOSTON, MA, 02205, US

(73) Assignee: INVENTEC CORPORATION, Taipei City (TW)

(21) Appl. No.: 12/437,655

(22) Filed: May 8, 2009

(30) Foreign Application Priority Data
Feb. 11, 2009 (TW) 098104274

(51) Int. Cl. G06F 15/177

(52) U.S. Cl. 713/2

(57) ABSTRACT

The invention provides a Basic Input/Output System (BIOS), a computer device and a method for recovering the BIOS. The BIOS includes a first boot block, a second boot block and a main BIOS block. The computer device includes a control chip disposed therein and said BIOS. When the programs in the first boot block and the main BIOS block are damaged, the second boot block can be selected so as for the BIOS to boot from the second boot block. Meanwhile, a recovery module of the second boot block can be utilized to recover the first boot block and/or the main BIOS block.

### BACKGROUND OF THE INVENTION

1. Field of the Invention

The present invention relates to a Basic Input/Output System (BIOS), a computer device and a method for recovering a BIOS.

2. Description of Related Art

A BIOS is an important system in a computer device. Generally, the BIOS is stored in a BIOS chip on the motherboard of a computer device, which acts as an interface between the system and the hardware of the computer device.

FIG. 1 shows the structure of a conventional BIOS. As shown in the drawing, the BIOS 1 comprises a first boot block 11, a non-volatile RAM 12, and a main BIOS block 13. Therein, the address of the first boot block 11 ranges from FFFF_{—}0000 to FFFF_FFFF, and the address of the non-volatile RAM 12 ranges from FFFE_{—}0000 to FFFF_{—}0000. The first boot block 11 generally stores boot programs and recovery programs for booting and recovering processes of the computer device, respectively. Therefore, the first boot block 11 is generally written to the BIOS chip when the BIOS is manufactured and cannot be changed through the operating system of the computer device such as Windows. The main BIOS block 13 generally stores POST programs and initialization programs. The initialization programs are used for recovering hardware settings such as storage units, the serial number and the global unique identifier. Generally, when the computer device is powered on, the computer device is booted through the boot programs stored in the first boot block 11 and then a POST process is performed through the POST programs stored in the main BIOS block 13 and the hardware settings are initialized and recovered through the initialization programs stored in the main BIOS block 13.

In the conventional BIOS, if the initialization programs in the main BIOS block 13 are damaged, a recovery programs in the first boot block 11 can be used to recover the initialization programs. However, if the boot programs and recovery programs in the first boot block 11 are lost or damaged, the computer device cannot be booted and the initialization programs cannot be recovered.

Therefore, there is a need to provide a BIOS, a computer device and a method for recovering a BIOS so as to overcome the above drawback.

### SUMMARY OF THE INVENTION

According to the above drawback, the present invention provides a Basic Input/Output System (BIOS), a computer device and a method for recovering the BIOS such that the computer device can be booted and the damaged programs in the main BIOS block can be recovered even if the programs in the first boot block are damaged or lost.

The present invention provides a BIOS stored in a BIOS chip of a computer device. The BIOS comprises: a main BIOS block; a first boot block for allowing the BIOS to boot from the first boot block if the first boot block is selected; and a second boot block for allowing the BIOS to boot from the second boot block if the second boot block is selected.

The present invention further provides a computer device, which comprises: a control chip disposed in the computer device; and a BIOS stored in a BIOS chip of the computer device, wherein the BIOS chip is electrically connected to the control chip, and the BIOS comprises: a main BIOS block; a first boot block for allowing the BIOS to boot from the first boot block if the first boot block is selected; and a second boot block for allowing the BIOS to boot from the second boot block if the second boot block is selected.

The present invention further provides a method for recovering a BIOS, at least comprising the steps of: providing a control chip disposed in a computer device; providing a BIOS stored in a BIOS chip of the computer device, wherein the BIOS chip is electrically connected to the control chip, and the BIOS comprises: a main BIOS block, a first boot block and a second boot block; determining whether the BIOS boots from the first boot block or the second boot block, such that if the first boot block is selected, the BIOS boots from the first boot block, and otherwise, if the second boot block is selected, exchanging an address of the first boot block and an address of the second boot block so as for the BIOS to boot from the second boot block.

According to the present invention, the BIOS comprises a first boot block, a second boot block and a main BIOS block. The computer device comprises a control chip disposed therein and said BIOS. When the content in the first boot block and the main BIOS block is damaged, the second boot block can be selected so as for the BIOS to boot from the second boot block. Meanwhile, a recovery module of the second boot block can be used to recover the first boot block and/or the main BIOS block, thereby ensuring normal initialization of the hardware of the computer device and subsequent operations of the computer device. Therefore, the present invention overcomes the conventional drawback.

### BRIEF DESCRIPTION OF DRAWINGS

FIG. 1 is a diagram showing the structure of a conventional Basic Input/Output System (BIOS);

FIG. 2 is a diagram showing the structure of a BIOS according to the present invention;

FIG. 3 is a diagram showing the structure of a computer device according to the present invention; and

FIG. 4 is a flow diagram showing a method for recovering a BIOS according to the present invention.

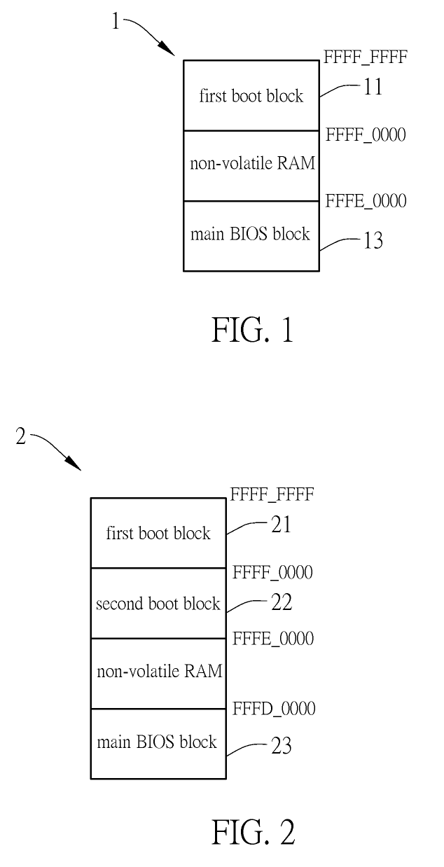

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

FIG. 2 shows a Basic Input/Output System (BIOS) according to the present invention. As shown in the drawing, the BIOS 2 comprises a first boot block 21, a second boot block 22, a non-volatile RAM and a main BIOS block 23, wherein the address range of the first boot block 21 is from FFFF_{—}0000 to FFFF_FFFF, the address range of the second boot block 22 is from FFFE_{—}0000 to FFFF_{—}0000, and the address range of the non-volatile RAM is from FFFD_{—}0000 to FFFE_{—}0000.

The BIOS 2 is generally stored in a BIOS chip (not shown).

The first boot block 21 stores boot programs for booting of the BIOS and comprises a recovery module for recovering the BIOS. In general, the first boot block 21 has a capacity of 64 kb and the first boot block 21 is located at the top of the BIOS address space, which however is not limited thereto.

The address of the second boot block 22 immediately follows the address of the first boot block 21 in the BIOS address space. Preferably, the second boot block 22 is a copy of the first boot block 21; in other words, the second boot block 22 has the same capacity as the first boot block 21 and the initial content stored in the second boot block 22 is the same as that in the first boot block 21. That is, the entire content of the first boot block 21 is copied to the second boot block 22 by a writer. Meanwhile, when the BIOS is updated by a BIOS update tool, the second boot block 22 is kept intact and not updateable.

If the first boot block 21 is selected, the BIOS 2 boots from the first boot block 21. If the second boot block 22 is selected, the BIOS 2 boots from the second boot block 22.

In particular, a computer device determines whether the BIOS boots from the first boot block 21, if the first boot block 21 is selected, the computer device boots from the first boot block 21 and then the hardware is initialized through the initialization programs in the main BIOS block 23. If the BIOS cannot boot from the first boot block 21, it means that the content in the first boot block 21 is damaged. Accordingly, the BIOS 2 boots from the second boot block 22 and the recovery module in the second boot block 22 is used to recover the content of the first boot block 21 and the main BIOS block 23.

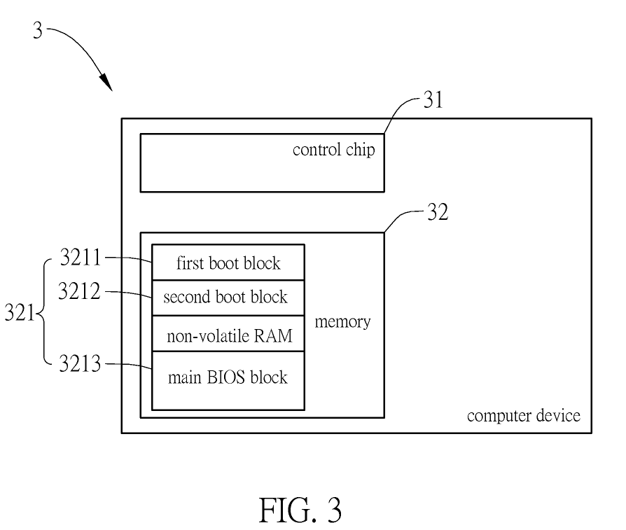

FIG. 3 shows a computer device 3 of the present invention, which comprises a control chip 31 and a BIOS chip 32.

The control chip 31 is a south bridge chip. The BIOS chip 32 is electrically connected to the control chip 31. A BIOS 321 is stored in the BIOS chip 32. The BIOS 321 comprises a first boot block 3211, a second boot block 3212, a non-volatile RAM and a main BIOS block 3213. Since the detailed structure of the BIOS has been described above, detailed description of the BIOS 321 is omitted hereby.

In general, the computer device 3 determines whether the BIOS 321 boots from the first boot block 3211. If the first boot block 3211 is selected, the boot process of the BIOS is completed through the boot programs stored in the first boot block 3211, and then the hardware of the computer device 3 is initialized through the initialization programs in the main BIOS block 3213. If the boot process is not completed, it means the content stored in the first boot block 3211 is damaged. Accordingly, the addresses of the first boot block 3211 and the second boot block 3212 are exchanged such that the second boot block 3212 is selected for booting of the BIOS 321. Meanwhile, the recovery module in the second boot block 3212 is used to recover the programs in the first boot block 3211 and the main BIOS block 3213. Preferably, the exchange of the addresses of the first boot block 3211 and the second boot block 3212 is achieved by changing the level of a pin of the control chip 31 via a jumper. In addition, the second boot block 3212 is free from being updated during a BIOS update.

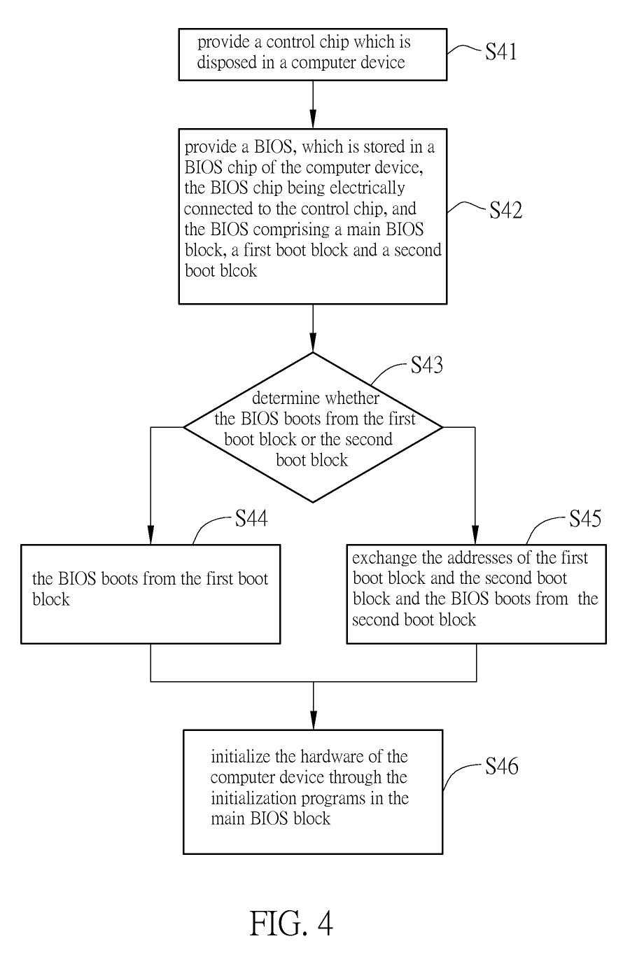

FIG. 4 shows a method for recovering the BIOS of the present invention, which comprises the following steps.

At step S41, a control chip disposed in a computer device is provided.

At step S42, a BIOS stored in a BIOS chip of the computer device is provided. Therein, the BIOS chip is electrically connected to the control chip, and the BIOS comprises a main BIOS block, a first boot block and a second boot block.

At step S43, whether the BIOS boots from the first boot block or the second boot lock is determined, if it is determined that the BIOS boots from the first boot block, i.e., the first boot block is selected, the process goes to step S44, otherwise, if it is determined that the BIOS boots from the second boot block, i.e., the second boot block is selected, the process goes to step S45.

At step S44, the BIOS boots from the first boot block. Then, the process goes to step S46.

At step S45, the addresses of the first boot block and the second boot block are exchanged and the BIOS boots from the second boot block. Then, the process goes to step S46. In general, the exchange of the addresses of the first boot block and the second boot block is achieved through the control chip, which involves changing the level of one pin of the control chip via a jumper. The control chip is a south bridge chip. For example, if the address of the first boot block ranges from FFFF_{—}0000 to FFFF_FFFF and the address of the second boot block 21 ranges from FFFE_{—}0000 to FFFF_{—}0000, when the level of one pin of the control chip is changed, the addresses of the first boot block and the second boot block are changed correspondingly. At this time, the address of the first boot block becomes ranging from FFFE_{—}0000 to FFFF_{—}0000, and the address of the second boot block now ranges from FFFF_{—}0000 to FFFF₋FFFF. Step S45 further comprises: if the first boot block is damaged, a recovery module in the second boot block is used to recover the first boot block and/or the main BIOS block. Then, the process goes to step S46.

At step S46, the hardware of the computer device is initialized through the initialization programs in the main BIOS block.

As described above, the BIOS of the present invention comprises a first boot block, a second boot block and a main BIOS block. The computer device of the present invention comprises a control chip disposed in the computer device and a BIOS chip with the BIOS stored therein. The method for recovering the BIOS comprises: when the content in the first boot block and the main BIOS block is damaged, the second boot block can be selected so as for the BIOS to boot from the second boot block. Meanwhile, a recovery module of the second boot block can be used to recover the first boot block and/or the main BIOS block, thereby ensuring normal initialization of the hardware of the computer device and subsequent operations of the computer device.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A Basic Input/Output System (BIOS) stored in a BIOS chip of a computer device, comprising:
a main BIOS block;
a first boot block for allowing the BIOS to boot from the first boot block if the first boot block is selected; and
a second boot block for allowing the BIOS to boot from the second boot block if the second boot block is selected.

2. The BIOS of claim 1, wherein the second boot block is free from being updated during a BIOS updating.

3. The BIOS of claim 1, wherein an initial content stored in the first boot block is the same as an initial content stored in the second boot block.

4. The BIOS of claim 1, wherein an address of the second boot block immediately follows an address of the first boot block.

5. A computer device, comprising:
a control chip disposed in the computer device; and
a Basic Input/Output System (BIOS) stored in a BIOS chip of the computer device, wherein the BIOS chip is electrically connected to the control chip, and the BIOS comprises:
a main BIOS block;
a first boot block for allowing the BIOS to boot from the first boot block if the first boot block is selected; and
a second boot block for allowing the BIOS to boot from the second boot block if the second boot block is selected.

6. The device of claim 5, wherein the second boot block is free from being updated during a BIOS updating.

7. The device of claim 5, wherein the control chip is used for exchanging an address of the first boot block and an address of the second boot block such that the BIOS can select booting from either the first boot block or the second boot block.

8. The device of claim 7, wherein the exchanging of the address of the first boot block and the address of the second boot block is achieved by changing a level of a pin of the control chip via a jumper.

9. The device of claim 5, wherein an initial content stored in the first boot block is the same as an initial content stored in the second boot block.

10. The device of claim 5, wherein an address of the second boot block immediately follows an address of the first boot block.

11. The device of claim 5, wherein the control chip is a south bridge chip.

12. A method for recovering a BIOS comprising the steps of:
(1) providing a control chip disposed in a computer device;
(2) providing a BIOS stored in a BIOS chip of the computer device, wherein the BIOS chip is electrically connected to the control chip, and the BIOS comprises a main BIOS block, a first boot block and a second boot block;
(3) determining whether the BIOS boots from the first boot block or the second boot block, such that if the first boot block is selected, the process goes to step (4), and otherwise, if the second boot block is selected, the process goes to step (5);
(4) having the BIOS boot from the first boot block; and
(5) exchanging an address of the first boot block and an address of the second boot block so as for the BIOS to boot from the second boot block.

13. The method of claim 12, wherein the step (5) further comprises: when the first boot block and the main BIOS block is damaged, a recovery module in the second boot block is used to recover the first boot block and/or the main BIOS block.

14. The method of claim 12, further comprising exchanging an address of the first boot block and an address of the second boot block through the control chip so as for the BIOS to boot from either the first boot block or the second boot block.

15. The method of claim 14, wherein the exchanging the address of the first boot block and the address of the second boot block is achieved by changing a level of a pin of the control chip via a jumper.

16. The method of claim 12, wherein the control chip is a south bridge chip.
